(19) United States
(12) Patent Application Publication
(10) Pub. No.: US 2009/0108157 A1
(43) Pub. Date: Apr. 30, 2009

(54) BATH ACCESSORY WALL MOUNTING INSTALLATION ASSURANCE

(76) Inventor: William Spencer, Burlington, NC (US)

Correspondence Address: Masco Corporation, 21001 Van Born Road, Taylor, MI, 48480, US

(21) Appl. No.: 11/927,728

(22) Filed: Oct. 30, 2007

(51) Int. Cl. A47G 29/08; F21V 21/00

(52) U.S. Cl. 248/222.13; 248/224.8

(57) ABSTRACT

A system for mounting an accessory to a wall includes structure which will provide feedback to an installer that the accessory has been properly and fully mounted to a clip that has been secured to the wall. In one embodiment, the feedback structure includes a detent which snaps into a groove when the accessory is properly and fully mounted.

### BACKGROUND OF THE INVENTION

This application relates to a bathroom accessory wall mount, wherein a detent ensures there will be feedback to an installer when the accessory is properly mounted.

Walls are often provided with accessory holding structures. As an example, towel bars, clips, etc. are often mounted to a wall. The attachment of these mounts has raised challenges in that, for aesthetic reasons, it is desirable not to have fasteners visible from a forward face of the wall mount. Thus, the attachment members and fasteners are often concealed.

In one known type of accessory mount, a clip is bolted to a wall. The clip has fingers received in slots in a rear face of the wall accessory. The clip is secured to the wall, and the slots are then moved over the fingers. The accessory is thus mounted to the wall.

However, in practice, the slots have not always been fully mounted on the fingers, and thus there has sometimes been less than optimal attachment.

### SUMMARY OF THE INVENTION

In a disclosed embodiment of this invention, fingers are received within slots in one of a clip and a wall accessory. The clip is secured to an underlying wall, and the slots are mounted on the fingers to hold the wall accessory to the clip. A detent is provided between the slots and the fingers such that there is feedback provided to an installer that installation has been successfully completed. In one embodiment, this includes a detent that snaps into a groove.

These and other features of the present invention can be best understood from the following specification and drawings, the following of which is a brief description.

### BRIEF DESCRIPTION OF THE DRAWINGS

FIG. 1 is an exploded view of the components of this invention.

FIG. 2 is a cross-sectional view through the assembled invention.

FIG. 3 shows an installation step.

### DETAILED DESCRIPTION OF THE PREFERRED EMBODIMENT

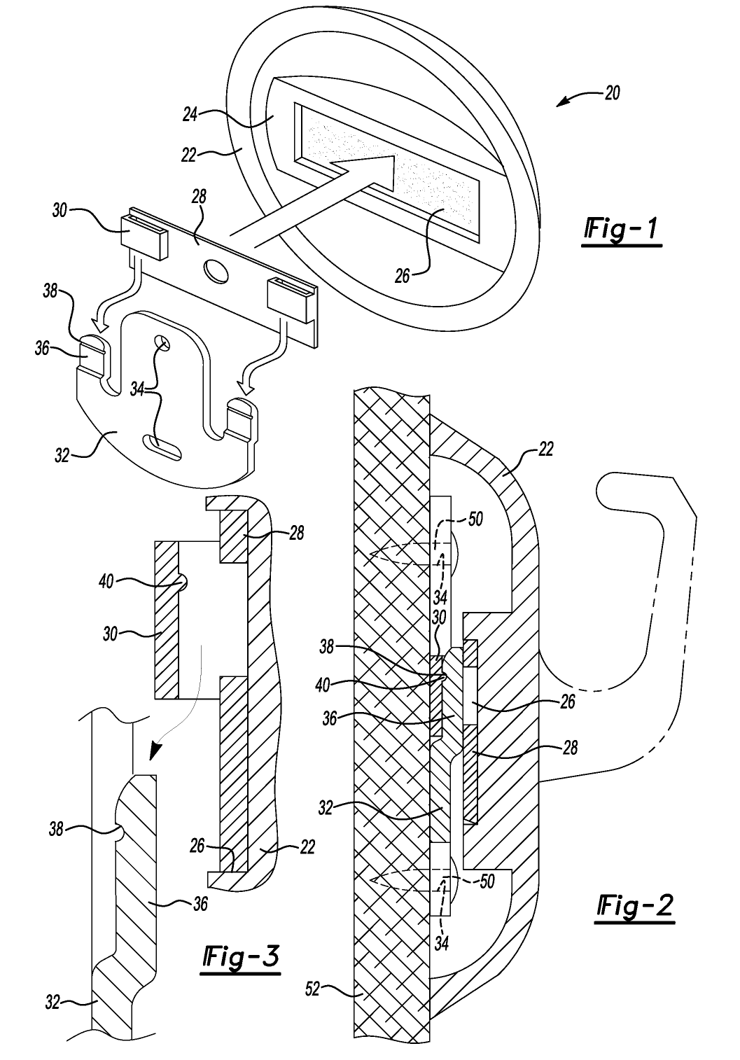

A wall accessory mounting system 20 is illustrated in FIG. 1. The wall accessory includes a mount cover 22 with a holding structure 24 including a space 26 on a rear face. A plate 28 is received within space 26. Plate 28 includes slots 30.

A clip 32 includes openings 34 to receive fasteners to secure the clip to an underlying wall. Fingers 36 are also formed on the clip. A groove 38 is formed in the fingers 36.

As shown in FIG. 2, the plate 28 has now been bolted by bolts 50 to an underlying wall 52. The wall accessory 22 is shown to be a hook, although the invention would extend to towel rack mounts, and any other accessory that is to be mounted to a wall. As known, the hook is on an outer or forward display surface.

The fingers 36 are shown received within the slots 30. As can be seen, detents 40 on the slots 30 snap into the groove 38.

As shown in FIG. 3, the plate 28 is positioned within the space 26 and the slots 30 are then moved onto the fingers 36. When the detent 40 snaps into the groove 38, feedback is provided to an installer that the accessory has been fully and properly mounted.

Although an embodiment of this invention has been disclosed, a worker of ordinary skill in this art would recognize that certain modifications would come within the scope of this invention. For that reason, the following claims should be studied to determine the true scope and content of this invention.

1. A wall mount accessory system comprising:
a member to be mounted to an underlying wall, said member having a forward display face for facing outwardly of a wall, and a rear surface with mount structure;
a clip to be secured to the underlying wall, and one of said clip and said mount structure having fingers, and the other of said clip and said mount structure having slots to be received on said fingers;
feedback structure provided on at least one of said slots and said fingers to provide feedback to an installer when said slots are fully received on said fingers; and
a detent on one of said slots and said fingers snaps into a groove on the other of said slots and said fingers.

2. (canceled)

3. The system as set forth in claim 1, wherein said detent formed on an outwardly facing surface of at least one of said slots, and said groove formed on a surface of at least one of said fingers that faces the wall when the system is installed.

4. The system as set forth in claim 1, wherein said mount structure is separate from said member.

5. A wall mounting system for attaching a bath accessory comprising:
a bath accessory including a forward display face for facing outwardly of an underlying wall, and a rearward internal space for receiving a plate, said plate having at least two slots;
a clip to be secured to the underlying wall, said clip having fingers for being received within said slots, and there being a detent on one of said fingers and said slots, and a groove on the other of said fingers and said slots, with said detents snapping into said grooves when said plate is fully received on said clip to provide feedback to an installer that said bath accessory has been properly mounted to said clip.
